(19) United States
(12) Patent Application Publication
(10) Pub. No.: US 2008/0120895 A1
(43) Pub. Date: May 29, 2008

(54) Rodent Management Apparatus

(75) Inventors: Guy Moshe Schwartz, Even Yehuda (IL); Eyal Yahalomi, Even Yehuda (IL)

Correspondence Address: WOLF, BLOCK, SHORR AND SOLIS-COHEN LLP, 250 PARK AVENUE, 10TH FLOOR, NEW YORK, NY, 10177, US

(73) Assignee: Hamelin Ltd., Even Yehuda, IL (US)

(21) Appl. No.: 11/814,500

(22) PCT Filed: Jan. 23, 2005
(86) PCT No.: PCT/IL05/00080

§ 371 Date: Jul. 23, 2007

(51) Int. Cl. A01M 19/00; A01M 23/08

(52) U.S. Cl. 43/61; 43/98; 43/99

(57) ABSTRACT

It is provided a rodent management apparatus for exterminating a plurality of rodents comprising extermination chamber provided with exterminating means, a preservation chamber adapted to receive exterminated rodent from the extermination chamber, and at least one of a plurality of open tubes connected to the extermination chamber and adapted to guide the rodents into the extermination chamber. Plurality of rodents is guided to enter into the tubes so as to reach the extermination chamber, where they are exterminated and removed to the preservation chamber while maintained in sanitary conditions.

### FIELD OF THE INVENTION

The present invention relates to rodent capturing and extermination. More particularly, the present invention relates to an apparatus adapted to attract the rodent into a trap, capturing it and exterminating and keeping it in sanitary conditions.

### BACKGROUND OF THE INVENTION

Rodent control is an issue that concerns the public as well as institutes, entities and even levels of governments. The efforts on rodent control are aimed at minimizing the risk of rodent-related diseases. The rodent problem is enhanced in warehouses, cargo handling areas, factory buildings etc., where the population of rodent is continuously increasing and capturing the rodents becomes a massive problem.

Rodent management is established by two main approaches: poison and traps. Generally, poisons are effective; however, the rats can die in places that are non-reachable and form a sanitary problem.

There are many types of traps such as spring snap traps, glue traps, catching traps etc. that are usually efficient for few rodents for a certain time. After a while, the rodent recognize the traps and avoid them. In places where the rodent population is relatively large and there are several rooms or large spaces, handling the traps, extermination the animal in some of the traps, and vacating the traps so as to allow further catch can be cumbersome and unsanitary.

There is a need to provide a trap in which more than one rodent is caught without the need to vacate the trap. Keeping the rodents that had been caught in such a trap in sanitary conditions is very important.

The use of rodent trap in which a plurality of rats is caught brings about the need to attract the animals to the trap instead of placing a plurality of traps in places where rodents travel, as is done nowadays.

Generally, there is a need to provide a rodent management apparatus that can be automatically controlled and can work for a predetermined time or is designed to catch a predetermined number of rodents.

### SUMMARY OF THE INVENTION

It is an object of the present invention to provide a rodent management apparatus adapted for attracting, capturing and treating the animals that are caught within the apparatus. Exterminating the animals is rapidly performed without inflicting the animal with excessive pain.

It is another object of the present invention to provide a rodent management apparatus in which the dead rodent is automatically removed so as to maintain the trap vacant while the dead rodent is maintained in cool conditions so as to avoid bad smells and spread of diseases.

It is yet another object of the present invention to provide a rodent management apparatus that attracts and guide rodents from many places and other spaces to enter the trap, where it is treated.

It is thus provided in accordance with the present invention a rodent management apparatus for exterminating a plurality of rodents, the apparatus comprising:
extermination chamber provided with exterminating means;
a preservation chamber adapted to receive exterminated rodent from said extermination chamber so as to keep said extermination chamber vacant and maintain said exterminated rodent in sanitary conditions;
at least one of a plurality of open tubes connected to said extermination chamber adapted to guide the plurality of rodents into said extermination chamber;

whereby the plurality of rodents are guided to enter said at least one of a plurality of tubes so as to reach said extermination chamber wherein each rodent that is exterminated within said extermination chamber is removed to said preservation chamber wherein said plurality of rodents is maintained.

Furthermore, in accordance with another preferred embodiment of the present invention, said exterminating means is at least one conductive plate adapted to electrocute the rodent.

Furthermore, in accordance with another preferred embodiment of the present invention, said at least one conductive plate is higher than a base on which it is provided.

Furthermore, in accordance with another preferred embodiment of the present invention, said preservation chamber is beneath said extermination chamber that is provided with a movable bottom that is adapted to move so as to allow said exterminated rodent to drop into said preservation chamber.

Furthermore, in accordance with another preferred embodiment of the present invention, said extermination chamber is further provided with means adapted to assure presence of a rodent within said extermination chamber and wherein said exterminating means is activated upon a signal generated by said means.

Furthermore, in accordance with another preferred embodiment of the present invention, said means is a light beam passing through said extermination chamber and hitting a receiver and wherein said signal is generated when said light beam does not hit said receiver.

Furthermore, in accordance with another preferred embodiment of the present invention, said at least one of a plurality of tubes is provided with at least one of a plurality of one way shutters adapted to allow the rodent to proceed solely towards said extermination chamber.

Furthermore, in accordance with another preferred embodiment of the present invention, said exterminating chamber is provided with a one way shutter through which the rodent enters said exterminating chamber.

Furthermore, in accordance with another preferred embodiment of the present invention, at least one one way shutter is provided in the apparatus so as to trap the rodent within the apparatus.

Furthermore, in accordance with another preferred embodiment of the present invention, further comprising an attracting means adapted to attract the plurality of rodents to enter said at least one of a plurality of tubes.

Furthermore, in accordance with another preferred embodiment of the present invention, said attracting means is a scent box and a fan directing the scent into said at least one of a plurality of tubes.

Furthermore, in accordance with another preferred embodiment of the present invention, said preservation chamber is cooled.

Furthermore, in accordance with another preferred embodiment of the present invention, said at least one of a plurality of tubes is flexible.

Furthermore, in accordance with another preferred embodiment of the present invention, said preservation chamber is provided with a rotating bucket.

Furthermore, in accordance with another preferred embodiment of the present invention, said preservation chamber is provided with a notification means adapted to generate an announcement when said preservation chamber is full.

Furthermore, in accordance with another preferred embodiment of the present invention, the apparatus is electrically operated.

Furthermore, in accordance with another preferred embodiment of the present invention, the apparatus is controlled by a controller that is adapted to control a sequence of actions in the apparatus.

Furthermore, in accordance with another preferred embodiment of the present invention, the apparatus is provided with wheels allowing portability.

It is therefore provided in accordance with yet another preferred embodiment of the present invention, a rodent management apparatus for exterminating a plurality of rodents, the apparatus comprising:
a central unit having a preservation chamber and a cover provided on top of said preservation chamber, wherein said cover comprises:
   space adapted to allow the plurality of rodents to travel within:
   extermination chamber connected to said space through a one way shutter, wherein said extermination chamber is provided with exterminating means and wherein said extermination chamber is further provided with a movable bottom adapted to move upon a signal so as to allow connection between said extermination chamber and said preservation chamber;
at least one of a plurality of open tubes adapted to guide the plurality of rodents into said space in said cover;

whereby the plurality of rodents are guided to enter said at least one of a plurality of tubes so as to reach said space and extermination chamber wherein each rodent that is exterminated within said extermination chamber is removed to said preservation chamber wherein said plurality of rodents is maintained.

Furthermore, in accordance with another preferred embodiment of the present invention, said preservation chamber is maintained in cool temperature so as to allow sanitary conditions.

Furthermore, in accordance with another preferred embodiment of the present invention, said space further provided with an attracting means adapted to attract the plurality of rodents into said space.

Furthermore, in accordance with another preferred embodiment of the present invention, said attracting means is a material having scent.

Furthermore, in accordance with another preferred embodiment of the present invention, the scent is spread using a fan.

Furthermore, in accordance with another preferred embodiment of the present invention, said at least one of a plurality of tubes is provided with at least one one way shutter adapted to guide the rodents to said central unit.

Furthermore, in accordance with another preferred embodiment of the present invention, said space is provided with at least one one way shutter.

Furthermore, in accordance with another preferred embodiment of the present invention, said extermination means is further provided with means adapted to assure presence of a rodent within said extermination chamber.

Furthermore, in accordance with another preferred embodiment of the present invention, said means is a light beam passing through said extermination chamber and hitting a receiver, and wherein said signal is generated when said light beam does not hit said receiver.

Furthermore, in accordance with another preferred embodiment of the present invention, said at least one of a plurality of tubes is flexible.

Furthermore, in accordance with another preferred embodiment of the present invention, said preservation chamber is provided with a rotating bucket that rotates upon receiving said signal.

Furthermore, in accordance with another preferred embodiment of the present invention, said preservation chamber is provided with a noticing means adapted to generate an announcement when said preservation chamber is full.

Furthermore, in accordance with another preferred embodiment of the present invention, said central unit is provided with a controller adapted to control operation in said central unit.

Additionally, in accordance with another preferred embodiment of the present invention, said central unit is provided with wheel to allow portability.

### BRIEF DESCRIPTION OF THE FIGURES

In order to better understand the present invention and appreciate its practical applications, the following Figures are attached and references herein. Like components are denoted by like reference numerals.

It should be noted that the figures are given as examples and preferred embodiments only and in no way limit the scope of the present invention as defined in the appending Description and Claims.

FIG. 1 illustrates rodents management apparatus in accordance with a preferred embodiment of the present invention.

FIG. 2 illustrates the apparatus shown in FIG. 1, having its cover partially opened so as to allow observation of the interior portions.

FIG. 3 illustrates rodent management apparatus in accordance with another preferred embodiment of the present invention, having a rotating bucket for preserving the dead animals.

FIG. 4 illustrates a cross sectional view of the apparatus shown in FIG. 3.

### DETAILED DESCRIPTION OF THE INVENTION AND FIGURES

The present invention provides a unique and novel rodent management apparatus that is adapted to attract, guide, capture, exterminate, and store the animals that are captured in the apparatus. The apparatus of the present invention is aimed at processing an enormous amount of rodents in an automatic manner without massive intervention of maintenance personnel. The novel management rodent apparatus comprises at least one of a plurality of tubes adapted to attract the rodent and guide him into a central unit. A scent adapted to attract the rodents is spread through the tubes from the central unit so as to draw the rodent into the tubes. The central unit is provided with an extermination chamber and maintaining chamber. It is preferable to exterminate the rodent that enters the chamber by electrocution; however, any other method can be employed. After the animal is dead, it is removed from the extermination chamber and is maintained in sanitary conditions.

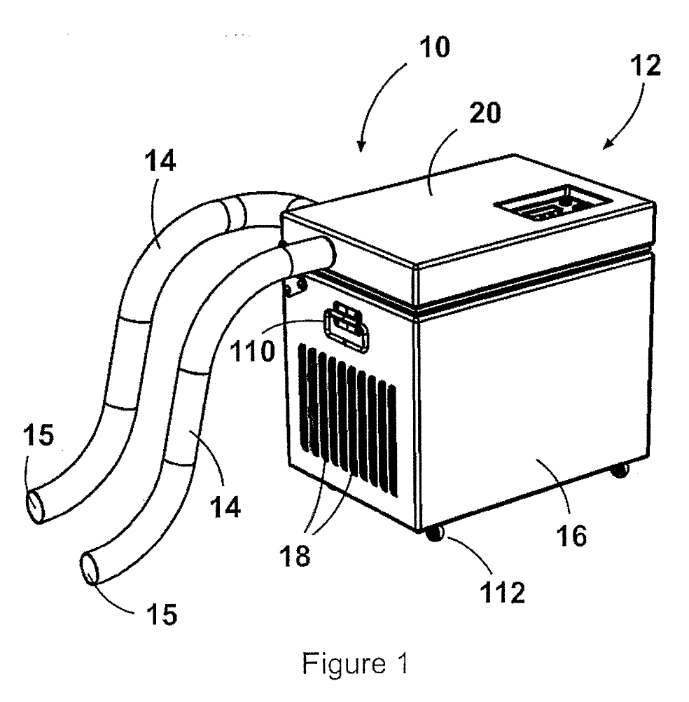

Reference is made to FIG. 1 illustrating rodents management apparatus in accordance with a preferred embodiment of the present invention. Rodents management apparatus 10 comprises a central unit 12 and a plurality of tubes 14 (FIG. 1 illustrates an apparatus comprising two tubes). Tubes 14 can be designed in any length or width according to the purpose of the apparatus. Tubes 14 are preferably flexible tubes and have opening 15 in their distal end. The tubes have preferably inner surface that is not smooth so as to ease the passage of the rodents inside the tubes. Central unit 12 comprises preservation chamber 16 that is aerated through a plurality of slots 18. Central unit 12 further comprises a cover 20 which interior contraction is further discussed.

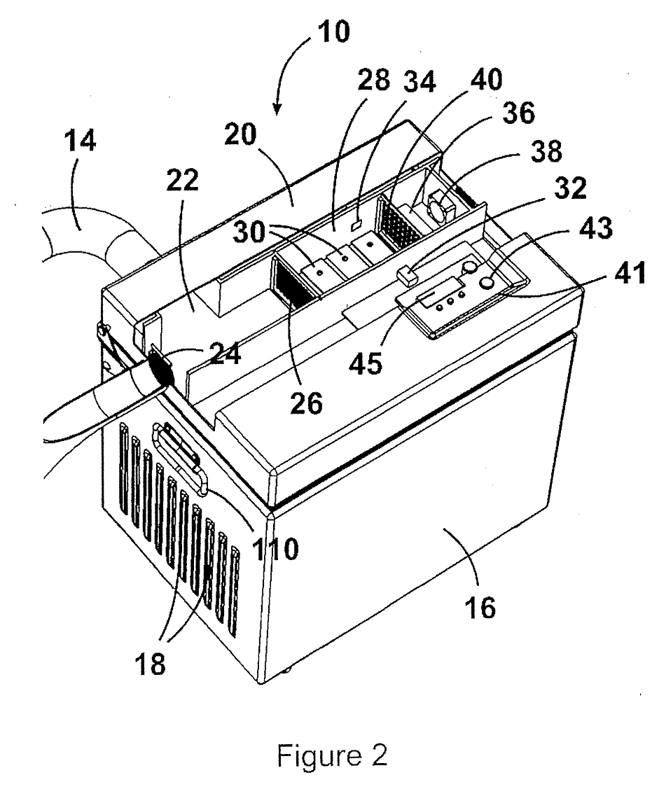

Reference is now made to FIG. 2 illustrating the apparatus shown in FIG. 1, having its cover partially opened so as to allow observation of the interior portions. Tubes 18 are connected to space 22 in cover 20 of apparatus 10. Tubes 18 are preferably provided with one way shutters along their length and are provided with one way shutter 24 in the zone where the tube is connected to space 22. The one way shutters are adapted to allow a rodent such as a rat to advance within the tube and into space 22 in the apparatus without the ability to go back and exit the apparatus. A rat that entered through an opening of one of the tubes (the opening of the tubes is not shown in FIG. 2) may travel along the tube. After passing through a first shutter, the rat cannot go back and has to proceed along the tube. The shutters are provided so as to assure the rat will eventually enter the central unit's cover area.

The rat that is captured within space 22 cannot go back into one of the tubes, however, it may pass through another one way shutter 26 that guide the rat into an extermination chamber 28 from which it cannot exit. Exterminating the animal is preferably performed using electricity means that are exterminating the animal in a rapid manner without inflicting extreme pain. The bottom of extermination chamber 28 is provided preferably with four conductive plates 30 that are adapted to electrocute the rat that stands on them.

Optionally, there is provided a means to assure that a rat had been caught in extermination chamber 28. Preferably, a beam of light is transmitted from a source 32 to a receiver 34. When light is not received by receiver 34, an electric current adapted to exterminate the animal is transferred through conductive plated 30.

Optionally, an attraction means and preferably a scent box 36 is provided in cover 20 wherein scent box 36 is adapted to spread a scent that attracts rodents. In order to spread the scent effectively through tubes 14, it is preferable to provide a fan 38 that allows the scent to pass through a screen 40, through the spaces in cover 20 and through the tubes. The rodents, as being curious animals, will be guided through the tubes into the cover of rodent management apparatus where they are exterminated. It should be noted that any other type of attraction means can be employed in the apparatus without limiting the cover of the present invention.

After the animal is exterminated, it is being removed of extermination chamber 28 to a preservation chamber 16 that is provided beneath cover 20. Preservation chamber 16 is maintained in cooling condition so as to prevent decay of the animals received within the chamber.

Apparatus 10 is provided with a controller 41 adapted to control the activation of the separated chambers and the sequence of operations in the apparatus. Optionally, controller 41 is provided with buttons 43 through which the user can change parameters of the apparatus. Optionally, controller 41 is provided with a display 45.

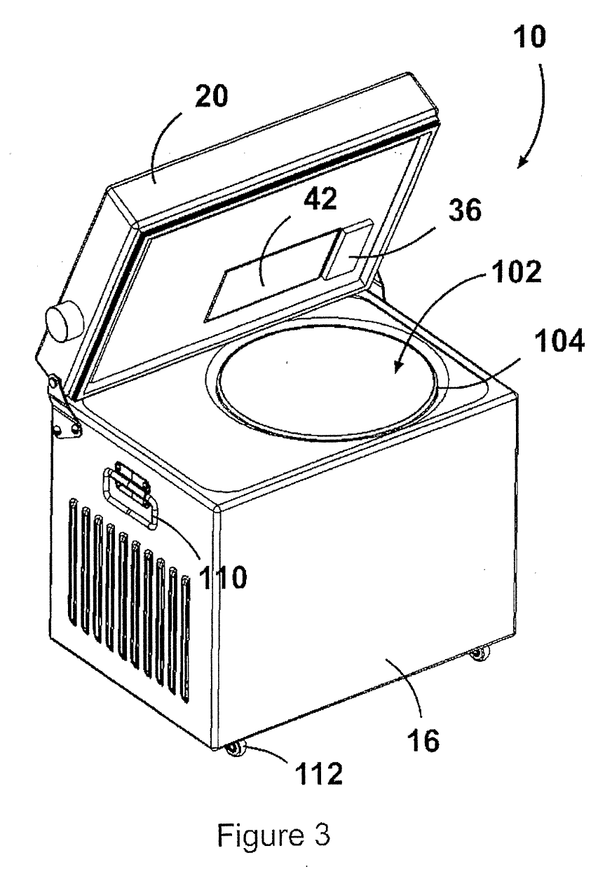

Reference is now made to FIG. 3 illustrating rodent management apparatus in accordance with another preferred embodiment of the present invention, having a rotating bucket for preserving the exterminated animals. Rodent management apparatus 100 is provided with a cover 20 that is similar to the cover shown in FIG. 2. Bottom of the extermination chamber 42 is movable and can be opened so as to allow the dead animal to be removed from extermination chamber and into a preservation chamber 102. According to the method of the present invention, after electrocution, bottom 42 is opened so as to allow the dead animal to be dropped beneath the extermination chamber and to keep the chamber vacant for entry of another rodent.

Preservation chamber 102 is provided with a bucket 104 that is adapted to be maintained in cool conditions so as to allow preservation of a plurality of rodents.

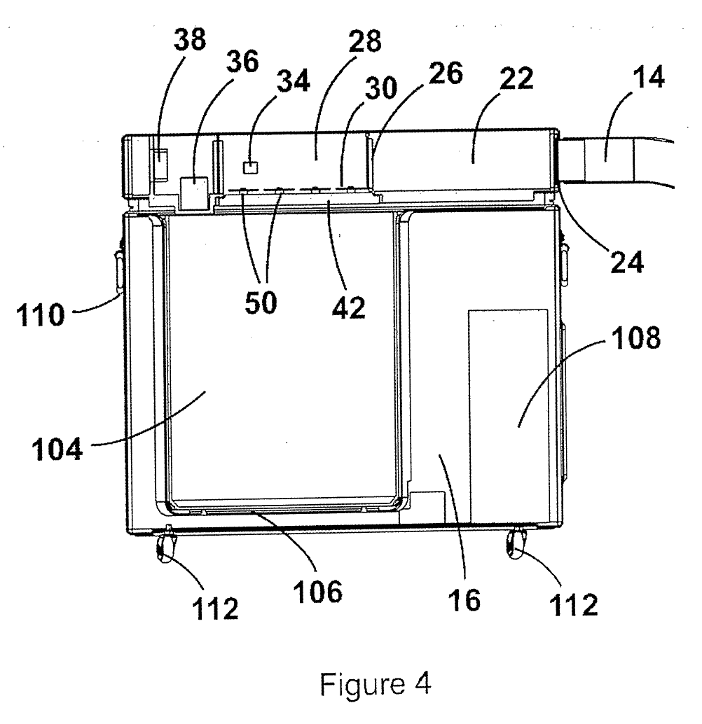

Reference is now made to FIG. 4 illustrating a cross sectional view of the apparatus shown in FIG. 3. Optionally, bucket 104 seats on a rotating base 106 adapted to rotate in a predetermined angle each time a rodent is dropped from extermination chamber 28. The rotation of the bucket assures that bottom 42 of extermination chamber 28 is not blocked by possible blockage by a plurality of dead animals that are stacked. The dead animals are evenly distributed within bucket 104. A refrigeration unit 108 is provided in preservation chamber 16 and is adapted to maintain the bucket in cool conditions.

Optionally, the apparatus is provided with notification means adapted to announce the user to empty preservation chamber 16. Notification means can comprise a scale beneath the bucket that weights the content of the bucket so as to announce the user that the bucket had reached a predetermined weight in which the bucket should be emptied. Another example of notification means is a counter that counts the number of times electrocution had been performed and announces the user to empty the bucket after a predetermined number of electrocutions. The predetermined number can be changed according to the size of the animals that are being caught in the apparatus. The counter can be integrated within controller 41. Another example is a height indicator that indicated the height of the animals in preservation chamber 16. The announcement to the user can be through display 45 in controller 41 or can be delivered through other means to the user such as to a computer or cellular phone. Any other notification and announcing means can be employed in the rodent management apparatus without limiting the scope of the present invention.

Optionally, bucket 104 is provided with a bag that facilitates the removal of the dead animals from the apparatus.

Optionally, each conductive plate 30 seats on a support 50 that slightly levels up the plates. This feature is provided in order to allow possible fluids that are secreted of the animals during electrocution to accumulate on bottom 42 rather than on conductive plates 30, a fact that can disturb the electrocution process.

Rodent management apparatus 10 and 100 are preferably provided with handles 110 adapted to allow movements of the apparatus as well as wheels 112 adapted to facilitate removing of the apparatus.

It should be noticed that the apparatus is electrically operated and controlled.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A rodent management apparatus for exterminating a plurality of rodents, the apparatus comprising:
extermination chamber provided with exterminating means;
a preservation chamber adapted to receive exterminated rodent from said extermination chamber so as to keep said extermination chamber vacant and maintain said exterminated rodent in sanitary conditions;
at least one of a plurality of open tubes connected to said extermination chamber adapted to guide the plurality of rodents into said extermination chamber;
whereby the plurality of rodents are guided to enter said at least one of a plurality of tubes so as to reach said extermination chamber wherein each rodent that is exterminated within said extermination chamber is removed to said preservation chamber wherein said plurality of rodents is maintained.

2. The apparatus as claimed in claim 1, wherein said exterminating means is at least one conductive plate adapted to electrocute the rodent.

3. The apparatus as claimed in claim 2, wherein said at least one conductive plate is higher than a base on which it is provided.

4. The apparatus as claimed in claim 1, wherein said preservation chamber is beneath said extermination chamber that is provided with a movable bottom that is adapted to move so as to allow said exterminated rodent to drop into said preservation chamber.

5. The apparatus as claimed in claim 1, wherein said extermination chamber is further provided with means adapted to assure presence of a rodent within said extermination chamber and wherein said exterminating means is activated upon a signal generated by said means.

6. The apparatus as claimed in claim 5, wherein said means is a light beam passing through said extermination chamber and hitting a receiver and wherein said signal is generated when said light beam does not hit said receiver.

7. The apparatus as claimed in claim 1, wherein said at least one of a plurality of tubes is provided with at least one of a plurality of one way shutters adapted to allow the rodent to proceed solely towards said extermination chamber.

8. The apparatus as claimed in claim 1, wherein said exterminating chamber is provided with a one way shutter through which the rodent enters said exterminating chamber.

9. The apparatus as claimed in claim 1, wherein at least one one way shutter is provided in the apparatus so as to trap the rodent within the apparatus.

10. The apparatus as claimed in claim 1, further comprising an attracting means adapted to attract the plurality of rodents to enter said at least one of a plurality of tubes.

11. The apparatus as claimed in claim 10, wherein said attracting means is a scent box and a fan directing the scent into said at least one of a plurality of tubes.

12. The apparatus as claimed in claim 1, wherein said preservation chamber is cooled.

13. The apparatus as claimed in claim 1, wherein said at least one of a plurality of tubes is flexible.

14. The apparatus as claimed in claim 1, wherein said preservation chamber is provided with a rotating bucket.

15. The apparatus as claimed in claim 1, wherein said preservation chamber is provided with a notification means adapted to generate an announcement when said preservation chamber is full.

16. The apparatus as claimed in claim 1, wherein the apparatus is electrically operated.

17. The apparatus as claimed in claim 1, wherein the apparatus is controlled by a controller that is adapted to control a sequence of actions in the apparatus.

18. The apparatus as claimed in claim 1, wherein the apparatus is provided with wheels allowing portability.

19. A rodent management apparatus for exterminating a plurality of rodents, the apparatus comprising:
a central unit having a preservation chamber and a cover provided on top of said preservation chamber, wherein said cover comprises:
space adapted to allow the plurality of rodents to travel within:
extermination chamber connected to said space through a one way shutter, wherein said extermination chamber is provided with exterminating means and wherein said extermination chamber is further provided with a movable bottom adapted to move upon a signal so as to allow connection between said extermination chamber and said preservation chamber;
at least one of a plurality of open tubes adapted to guide the plurality of rodents into said space in said cover;
whereby the plurality of rodents are guided to enter said at least one of a plurality of tubes so as to reach said space and extermination chamber wherein each rodent that is exterminated within said extermination chamber is removed to said preservation chamber wherein said plurality of rodents is maintained.

20. The apparatus as claimed in claim 19, wherein said preservation chamber is maintained in cool temperature so as to allow sanitary conditions.

21. The apparatus as claimed in claim 19, wherein said space further provided with an attracting means adapted to attract the plurality of rodents into said space.

22. The apparatus as claimed in claim 21, wherein said attracting means is a material having scent.

23. The apparatus as claimed in claim 22, wherein the scent is spread using a fan.

24. The apparatus as claimed in claim 19, wherein said at least one of a plurality of tubes is provided with at least one one way shutter adapted to guide the rodents to said central unit.

25. The apparatus as claimed in claim 19, wherein said space is provided with at least one one way shutter.

26. The apparatus as claimed in claim 19, wherein said extermination means is further provided with means adapted to assure presence of a rodent within said extermination chamber.

27. The apparatus as claimed in claim 26, wherein said means is a light beam passing through said extermination chamber and hitting a receiver, and wherein said signal is generated when said light beam does not hit said receiver.

28. The apparatus as claimed in claim 19, wherein said at least one of a plurality of tubes is flexible.

29. The apparatus as claimed in claim 19, wherein said preservation chamber is provided with a rotating bucket that rotates upon receiving said signal.

30. The apparatus as claimed in claim 19, wherein said preservation chamber is provided with a noticing means adapted to generate an announcement when said preservation chamber is full.

31. The apparatus as claimed in claim 19, wherein said central unit is provided with a controller adapted to control operation in said central unit.

32. The apparatus as claimed in claim 19, wherein said central unit is provided with wheel to allow portability.

33. A rodent management apparatus substantially as described in the above specification, attached Figures and appending claims.
